(19) United States
(12) Patent Application Publication
(10) Pub. No.: US 2008/0295503 A1
(43) Pub. Date: Dec. 4, 2008

(54) Method for using the expanion of hydrogen and oxygen gases during Electrolysis to produce electricity by means of turning small DC generators

(76) Inventor: Sean Arthur Shea, East Rockaway, NY (US)

Correspondence Address: Sean Shea, 67 Seawane Rd, East Rockaway, NY, 11518, US

(21) Appl. No.: 11/757,543

(22) Filed: Jun. 4, 2007

(51) Int. Cl. H02K 16/00

(52) U.S. Cl. 60/327

(57) ABSTRACT

The present invention provides a method for making the production of hydrogen during electrolysis more efficient. By using the expansion of hydrogen and oxygen during electrolysis to produce electricity by turning air pressure wheels attached to DC generators, allows us to harvest the pressure the gases make in their sealed sections of the apparatus. By using the rising of the gas bubbles in the electrolytic solution to turn several small wheel attached to small DC generators, allows us to harvest power from their motion to the top of the apparatus. This invention does not alter the oxygen gas or hydrogen gas in any way, allowing both gases to be used or stored in their pure form. The energy gained by this method is directed back to the DC power source and makes the production of hydrogen and water more efficient by replacing electrical energy lost in the form of heat during electrolysis.

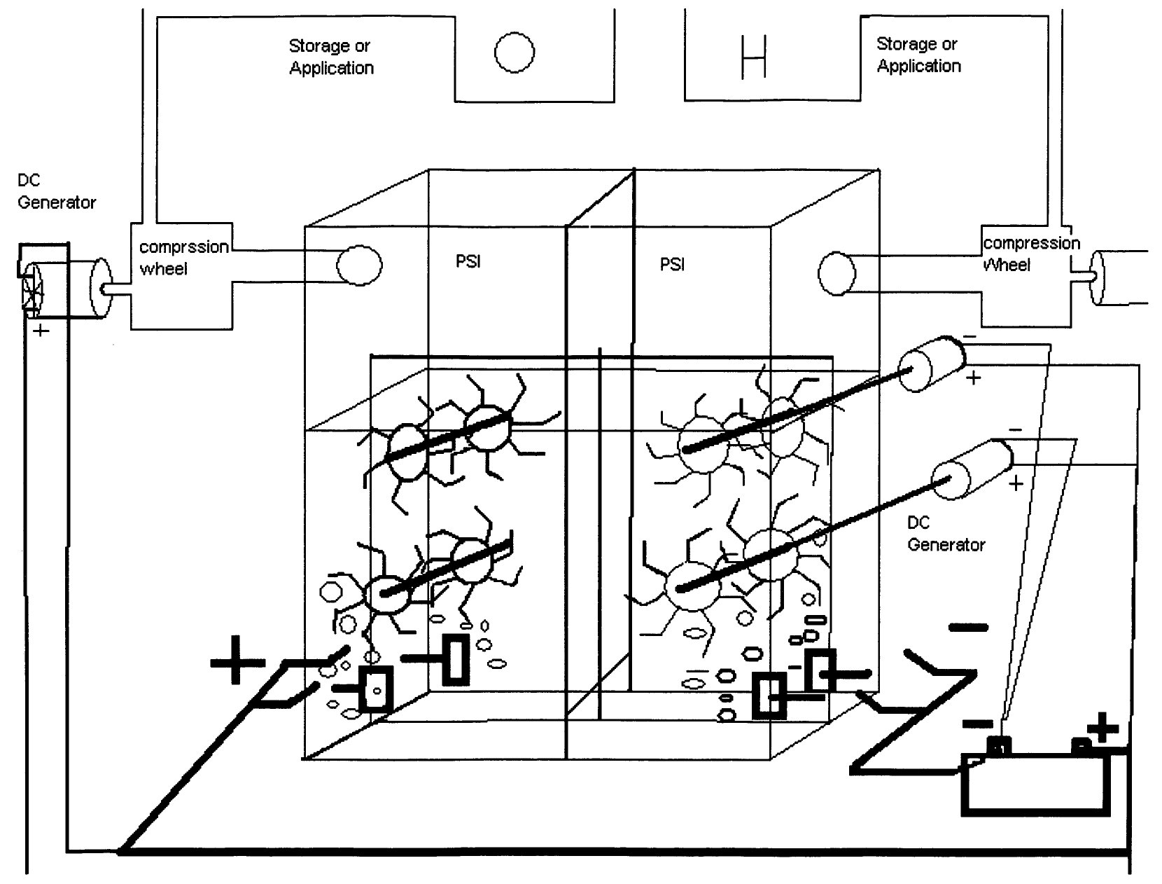

The main container led cube shape, constructed of non-corrosive material such as plastic. The bottom of the container holds the electrolytic solution, the top has two separate compartments to hold gas and a tube connected to each compartment outside the container. The container holds:
1) Electrolytic solution—Water plus conductive solution: Sulfuric acid, salt, sodium, etc.
2) Anode—Conductor that will not react chemically with solution: Stainless steel, graphite, carbon, etc.
3) Cathode—Conductor that will not react chemically with solution: Stainless steel, graphite, carbon, etc.
4) Several small wheels to be placed under water to catch gas bubbles in solution.
5) Dividers positioned to divert bubbles to correct side of wheels.
6) Several small DC generators to be attached to armatures of wheels from (#4).
7)Two small gas compression wheels (ex. Air tools). One for O2 side of apparatus, one for H2 side.
8) Gas storage system, or direct use application.
9) A DC power source (ex. Battery) hooked up to anode (#2) and cathode (#3) to dissociate hydrogen from oxygen in the water solution.
10) Two or more DC generators to be connected to armature of compressed gas wheels (#7). In which the expansion of hydrogen and oxygen in separate sections of apparatus will create the pressure to turn their respective armatures. In which the power generated by DC generators will be returned to the DC power source (battery).

### DESCRIPTION

A DC power source provides electricity to the the Anode and Cathode at opposite sides of the container in the electrolytic solution. As Hydrogen bubbles collect on one conductor the Oxygen collects on the other. As the gases rise on opposite sides of the solution they turn several small wheels in the solution, the armature of wheels are attached to generators in a compartment at the top of the tank or to a submersible generator in the solution. The wheels are positioned vertically and dividers are positioned to divert bubbles to the correct side of wheels. Several small DC generators are attached to the armatures of the wheels, as the wheels turn generators attached the their armatures produce electricity. Since the gas bubbles rise at a constant rate the number of wheels on each side depend on the size of the container. Once the gases pass the wheels they will collect at the top to section: Hydrogen side, Oxygen side. The pressure of the gasses will build up in each section and released through a tube. As the gasses pass through their tube they will turn two small gas compression wheels. One for Oxygen side of apparatus, one for Hydrogen side. Two or more DC generators are connected to the armatures of the compressed gas wheels in which the expansion of hydrogen and oxygen in separate sections of apparatus will create the pressure to turn their respective armatures. The gasses can then be used or stored in their pure form. The power generated by DC generators will be returned to the DC power source.

What is claimed is:

1. The present invention is a method for using the expansion of hydrogen and oxygen gases during the electrolysis of water to produce electricity by means of turning small direct current generators. The main container is a sealed cube shape, constructed of non-corrosive material such as plastic. The bottom of the container holds the electrolytic solution, the top has two or four compartments (depending where generators are placed). Two compartments are for the hydrogen and oxygen gases the other two for the generators.
